(19) United States
(12) Patent Application Publication
(10) Pub. No.: US 2019/0388997 A1
(43) Pub. Date: Dec. 26, 2019

(54) LOAD SENSING FOR FRICTION WELDING

(71) Applicant: MaxQ Technology, LLC, Tempe, AZ (US)

(72) Inventor: Joe L. Martinez, JR., Scottsdale, AZ (US)

(21) Appl. No.: 16/014,526

(22) Filed: Jun. 21, 2018

(51) Int. Cl. B23K 20/12; B23Q 17/09

(52) U.S. Cl. CPC B23K 20/123; B23Q 17/09; B23K 20/126

(57) ABSTRACT

A welder assembly includes a welding mechanism; a carriage plate, the welding mechanism fixedly coupled to the carriage plate; a translation assembly, the carriage plate fixedly coupled to the translation assembly, the translation assembly comprising a force sensor; a ball screw, the translation assembly moveably coupled to the ball screw; and, an axial drive motor coupled to the ball screw, wherein the ball screw is movably coupled to the translation assembly such that rotation of the axial drive motor forces linear translation of the translation assembly.

### TECHNICAL FIELD

This disclosure relates to friction welding. More specifically, this disclosure relates to load sensing in friction welding.

### BACKGROUND

Welding can allow for the simple joining of at least two material workpieces. In friction welding, energy can be generated through friction by sliding workpieces with respect to one another or by use of a tool to generate energy of friction. At high enough energy, materials of the two material workpieces can be plasticized without melting and joined.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

A welder assembly includes a welding mechanism; a carriage plate, the welding mechanism fixedly coupled to the carriage plate; a translation assembly, the carriage plate fixedly coupled to the translation assembly, the translation assembly comprising a force sensor; a ball screw, the translation assembly moveably coupled to the ball screw; and, an axial drive motor coupled to the ball screw, wherein the ball screw is movably coupled to the translation assembly such that rotation of the axial drive motor forces linear translation of the translation assembly.

A force-sensing attachment for a welder assembly includes a carriage plate; a translation assembly, the carriage plate fixedly coupled to the translation assembly, the translation assembly comprising a force sensor; and a linear actuator, the translation assembly moveably coupled to the linear actuator.

A method of controlling a welding apparatus includes obtaining force sensor data from a force sensor located within a translation assembly, the translation assembly being fixedly coupled to a carriage plate and being movably coupled to a ball screw, wherein the translation assembly comprises a ball screw nut coupled to the ball screw and a nut housing coupled to the carriage plate, wherein the force sensor is arranged between the ball screw nut and the nut housing; and rotating the ball screw to modify the amount of force sensed by the force sensor.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a welder assembly in accordance with one aspect of the current disclosure.

FIG. 2 is an exploded close-up view of the welder assembly of FIG. 1.

FIG. 3 is a top perspective view of the welder assembly of FIG. 1.

FIG. 4 is a side perspective view of the welder assembly of FIG. 1 with various parts hidden from view.

FIG. 5 is a close-up side perspective view of a ball screw and translation assembly of the welder assembly of FIG. 1.

FIG. 6A is a front view of a ball screw nut of the translation assembly of the welder assembly of FIG. 1.

FIG. 6B is a side view of the ball screw nut of FIG. 6A.

FIG. 6C is a front view of a force sensor of the translation assembly of the welder assembly of FIG. 1.

FIG. 6D is a side view of the force sensor of FIG. 6C.

FIG. 7 is a block diagram of a feedback control system of the welder assembly of FIG. 1.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a load sensor for use in a machine and associated methods, systems, devices, and various apparatus. The load sensor can be utilized in friction welding. It would be understood by one of skill in the art that the disclosed load sensor is described in but a few exemplary embodiments among many. No particular terminology or description should be considered limiting on the disclosure or the scope of any claims issuing therefrom.

Friction welding processes encompass many different variants, including rotary friction welding, linear friction welding, and friction stir welding (FSW). In each case, friction can heat the material to a plastic state in conjunction with an applied force to create a weld. In some situations, no melting occurs, and, in such applications the processes are classified as solid-state welding

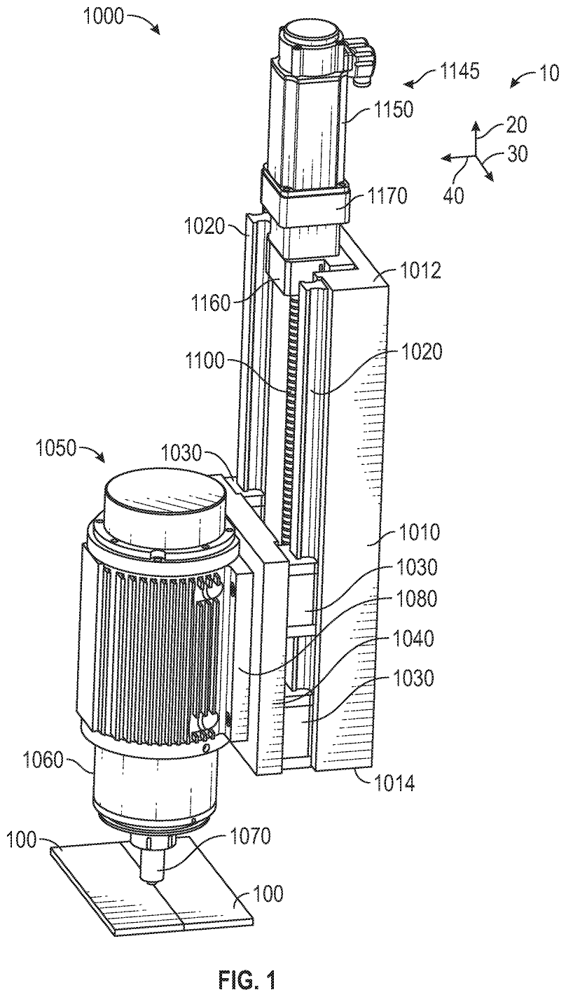

One embodiment of a friction welder assembly 1000 is disclosed and described with reference to FIG. 1. The friction welder assembly 1000 of the current aspect can be a friction stir welding assembly. In various aspects, features of the friction welder assembly 1000 can be utilized in applications not related to friction stir welding, such as CNC milling, sensing milling cutting forces, sonic welding, or various other force-sensing applications. A reference coordinate system 10 can be defined with a z-direction 20 being up and down, an x-direction 30 being orthogonal to the z-direction 20 and defined as “left and right,” and a y-direction 40 being orthogonal to both the x-direction 30 and the z-direction 20 and defined as “front and back.” The friction welder assembly 1000 can be configured to be attached or connected to a milling machine or other similar manufacturing apparatus. The friction welder assembly 1000 can be utilized to accomplished friction stir welding processes in various aspects. For the sake of the current disclosure, friction stir welding can comprise the process of plunging a tool into a plurality of workpieces to be joined along a joint between the workpieces and rotating the tool to generate frictional welding of the workpieces. For the sake of the current disclosure, plunging can occur in the z-direction 20. The rotating tool can then be translated linearly to accomplish welding along an entirety of the joint. For the sake of the current disclosure, the linear translation for joining can occur in the x-direction 30 or the y-direction 40, or both. In various aspects, joining can occur along radii or curvature.

The friction welder assembly 1000 can comprise a support 1010. In various aspects, the support 1010 can be attached, connected, or otherwise mounted to a milling machine or other similar manufacturing machine. As such, the friction welder assembly 1000 in various aspects can represent the “z-axis drive” of such a machine. Linear rails 1020 can be attached or connected to the support 1010. The linear rails 1020 can serve as guides and/or load bearing elements for rail runners 1030 to travel along. In various aspects, the linear rails 1020 and the rail runners 1030 can be connected with respect to one another in various relationships, such as ball bearings, lubricated sliders, or various other low-friction relationships. In various aspects, the rail runners 1030 can be decoupled from the linear rails 1020. In various aspects, the rail runners 1030 can be independently movable in at least one direction with respect to the linear rails 1020. In various aspects, the rail runners 1030 can be arranged and placed in relationship to the linear rails 1020 such that the rail runners 1030 are movable in only one direction with respect to the linear rails 1020. In various aspects, the arrangement of the linear rails 1020 and rail runners 1030 can be reversed. In various aspects, frictional force exhibited by the connection between the linear rails 1020 and the rail runners 1030 can be de minimis with respect to the amount of force loads exhibited within the friction welder assembly 1000 and, thus, can be ignored. Rail runners 1030 can be attached or connected to a carriage plate 1040 in various aspects. In various aspects, the welding assembly 1000 can be utilized in box guide way construction or linear guide construction as would be understood by one of skill in the art.

A welding mechanism 1050 can comprise a spindle motor 1060 and a tool 1070. The tool 1070 can be attached to the spindle motor 1060 and can be configured to engage a plurality of workpieces 100 for welding. The welding mechanism 1050 can be connected or attached to the carriage plate 1040 by a mount 1080 that can connect or attach to the spindle motor 1060.

Various attachment, connection, or mount apparatus can be used within the scope of the current disclosure. Attachments or connections can be achieved by mechanical coupling, such as by screws, fasteners, rivets, or the like; by joining, such as by welding, co-molding, forging, or various other joints; or by adhesion, such as with glues or other adhesives, among others. One of skill in the art would understand that the various connections or attachments could be utilized within the scope of the current disclosure.

Translational motion of the welding mechanism 1050 into the workpieces 100 can be achieved by coupling of a ball screw 1100 to the carriage plate 1040 in arrangement to translate rotation of the ball screw 1100 into linear motion. The ball screw 1100 can be coupled along one end to an axial drive motor 1150. The axial drive motor 1150 can generate rotational energy of the ball screw 1100. In various aspects, the ball screw 1100 can be replaced with various linear actuators, including but limited to machine screws, solenoids, gear arrangements, hydraulics, and piston assemblies, among other types of linear actuators.

Various elements cited in this paragraph can comprise an upper end assembly 1145. A thrust coupling 1160 can be attached or connected to the support 1010 proximate an upper end 1012 of the support 1010. The support can also define a lower end 1014. The thrust coupling 1160 can serve as a connection point of a motor mount 1170, which can be attached or connected to the thrust coupling 1160. The axial drive motor 1150 can be attached or connected to the motor mount 1170.

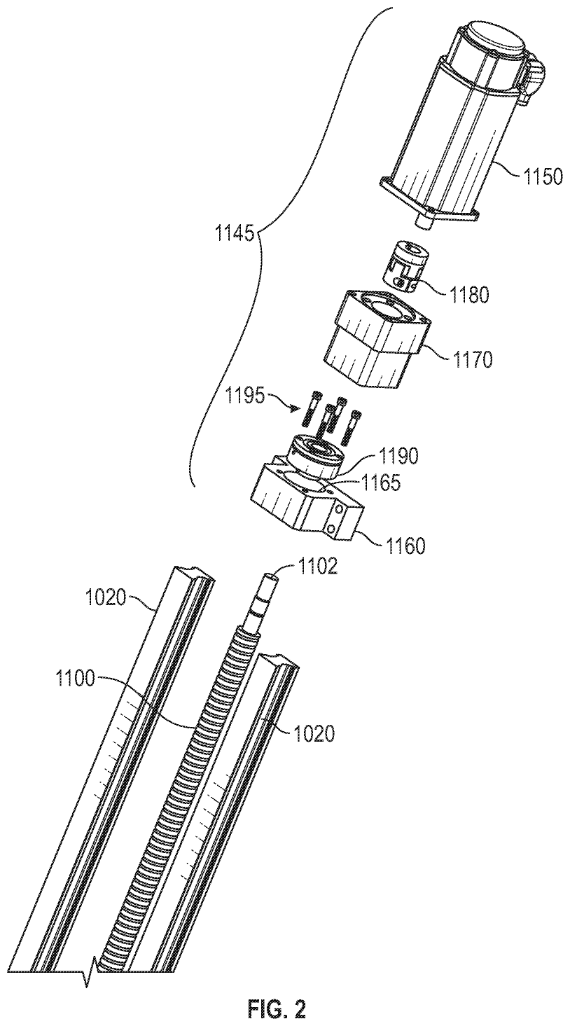

As seen with reference to FIG. 2, the axial drive motor 1150 can be coupled to an upper end 1102 of the ball screw 1100 using a coupling 1180. A thrust bearing 1190 can be utilized to distribute force loads within the upper end assembly 1145. In the current aspect, the thrust coupling 1160 can define a bearing recess 1165 sized to accept the thrust bearing 1190. Fasteners 1195 are shown and can be utilized to attach the motor mount 1170 to the thrust coupling 1160.

As seen with reference to FIG. 3, a translation assembly 1200 can be seen located within a channel 1019 of the support 1010. The channel 1019 can provide a location between the linear rails 1020 for location of various elements to drive the welding mechanism 1050 into engagement with the workpieces 100. The translation assembly 1200 can be driven by the ball screw 1100 and coupled to the carriage plate 1040 to translate the rotational motion of the ball screw 1100 into linear motion of the welding mechanism 1050.

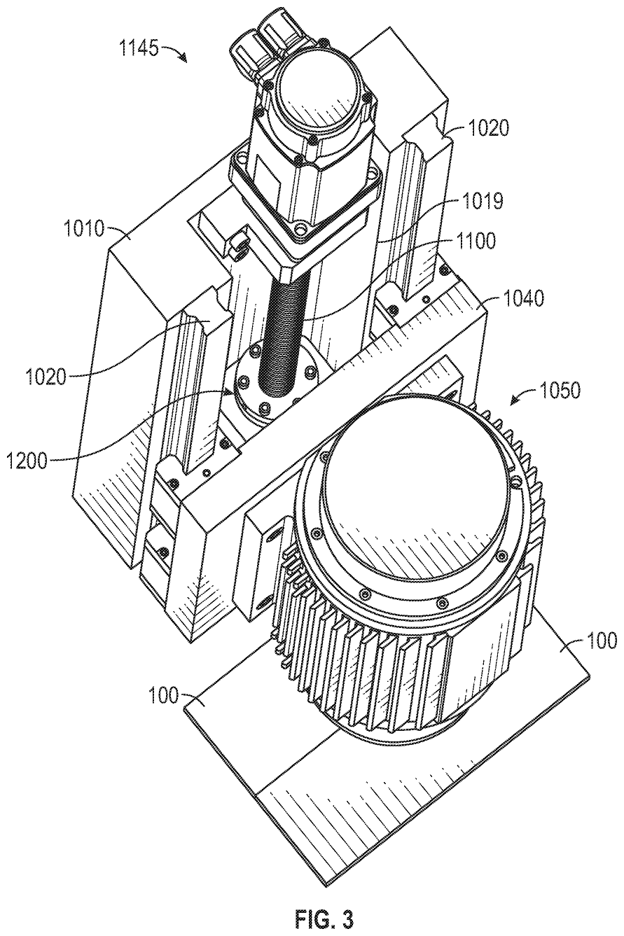

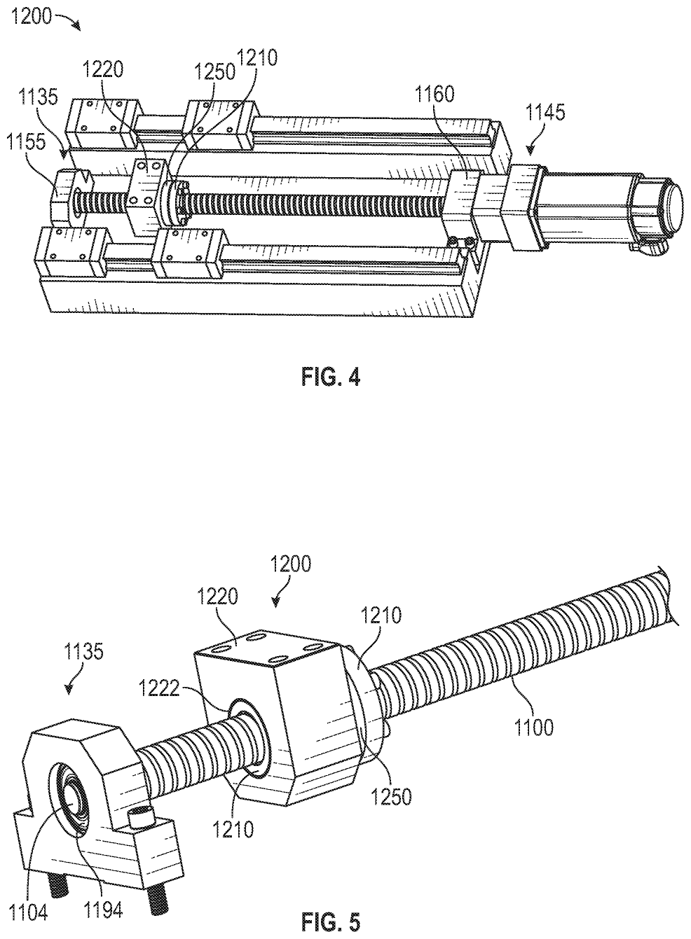

With reference to FIG. 4, the translation assembly 1200 can be seen when the carriage plate 1040 and the remaining elements of the welding mechanism 1050 are removed from view. A lower end assembly 1135 can also be seen at a lower end 1104 (seen with reference to FIG. 5) of the ball screw 1100 and can comprise a thrust bearing 1194 (seen with reference to FIG. 5) located within a thrust coupling 1155 in similar relationship as the thrust bearing 1190 and the thrust coupling 1160. The translation assembly 1200 can comprise a ball screw nut 1210 that can be connected or attached to a nut housing 1220. The nut housing 1220 can further be attached or connected to the carriage plate 1040, and, when done, translational motion of the translation assembly 1200 can cause motion of the carriage plate 1040 and thereby the welding mechanism 1050.

Downward forces of welding can be in excess of 100 kN (100,000 Newtons) when friction welding aluminum depending on thickness and application. As such, the elements of the various assemblies can experience extreme forces and, in some cases, large variations in force. Because of the large variations in force, it is possible that the tool 1070 can be in varying engagement with the workpieces 100. If the tool 1070 is not in constant engagement with the workpieces 100, the weld can be compromised, and the welding mechanism 1050 can be unreliable for performing desired friction welding. As such, the inclusion of a force sensing capability can allow the operator of the welder assembly 1000 some feedback as to how the tool 1070 is engaging with the workpieces 100.

A force sensor 1250 can be arranged between the ball screw nut 1210 and the nut housing 1220 to sense the amount of force being applied to the workpieces 100. Maintenance of constant welding force can be critical to the success of a weld. In various aspects, welding loads can spike above 2.5× the expected load for rating purposes. As a result, constant downforce on the workpieces 100 can be supplied by engagement of the axial drive motor 1150 turning the ball screw 1100, which therein causes the ball screw nut 1210 to translate linearly in the direction of the ball screw 1100 which is substantially in the z-direction 20. As such, the downward force supplied can bear on the ball screw nut 1210, through the force sensor 1250 to the nut housing 1220, thereby allowing the force sensor 1250 to supply reliable reading of the force supplied to the tool 1070 and, thereby, into the workpieces 100.

Various types of force sensor mechanisms can be utilized within the scope of the disclosure. One suitable force sensor mechanism can be a strain gauge load cell. In various aspects, a piezoelectric load sensor can be utilized. In various aspects, multiple force sensor mechanisms can be utilized in series or in parallel. In various aspects, the multiple force sensor mechanisms can be of the same type of load sensing arrangement, and in various aspects multiple different force sensor mechanisms can be utilized.

As seen with reference to FIG. 5, the nut housing 1220 can define a nut recess 1222 that can be sized to accept a portion of the ball screw nut 1210. The force sensor 1250 can be sized to accept a portion of the ball screw nut 1210 and can be arranged between the nut housing 1220 and another portion of the ball screw nut 1210.

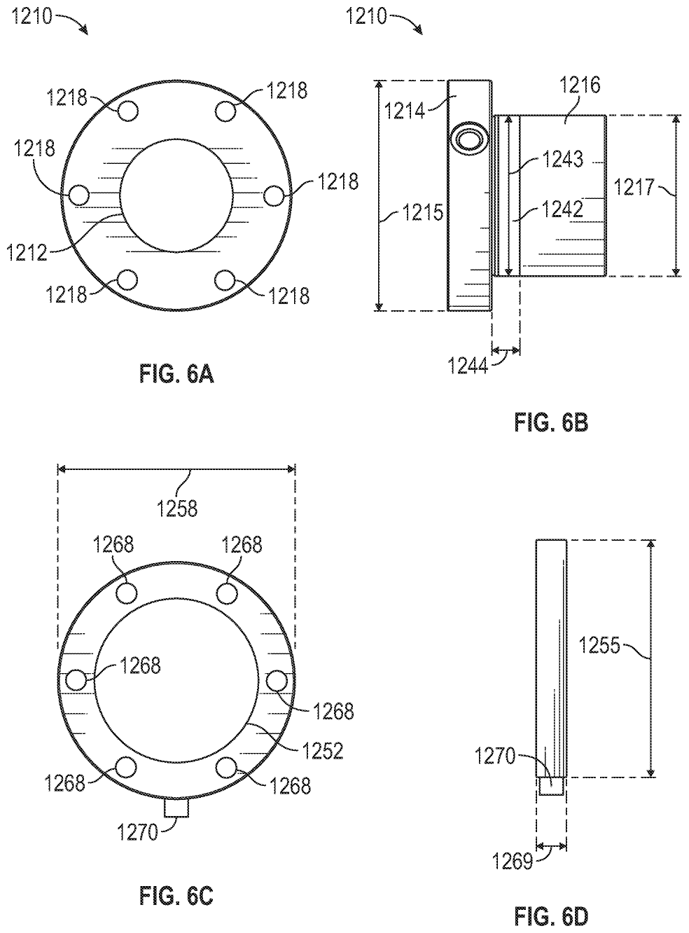

The arrangements of the ball screw nut 1210 and the force sensor 1250 can be seen in greater detail with reference to FIGS. 6A-6D. The ball screw nut 1210 and the force sensor 1250 of the current aspect can be about annular, and, in various aspects, can be symmetrical about a center axis. As can be seen, the ball screw nut 1210 defines a ball screw recess 1212 arranged centrally to the ball screw nut 1210 along an entire length of the ball screw nut 1210. The ball screw recess 1212 accepts the ball screw 1100 and includes corresponding features to allow the ball screw nut 1210 to translate along the ball screw 1100 in response to turning of the ball screw 1100. The ball screw nut 1210 can comprise a shoulder portion 1214 and a collar portion 1216. The shoulder portion 1214 can be of a greater diameter 1215 than a diameter 1217 of the collar portion 1216. In various aspects, the diameters 1215, 1217 can be of various measurements. In the current aspect, the diameter 1215 can be about 80.00 mm and the diameter 1217 can be about 55.95 mm. The ball screw nut 1210 can define a plurality of fastener apertures 1218 spaced about equally about the circumference of the ball screw nut 1210 and adapted for attachment of the ball screw nut 1210 to the nut housing 1220. The collar portion 1216 can be defined adjacent to a sensor location portion 1242. The sensor location portion 1242 can be said to be a part of the collar portion 1216 in various aspects. The sensor location portion 1242 can be of a length 1244 of about 10 mm and of a diameter 1243 of about 56.00 mm, or about 0.05 mm greater than the diameter 1217 of the collar portion 1216 generally. In various aspects, the dimensions of the various parts can be of various shapes and sizes.

Similarly, the force sensor 1250 can be ring-shaped in various aspects. In various aspects, the force sensor 1250 can be an assembly of parts, wherein a portion of the force sensor 1250 can be comprised of assembly parts and a portion of the force sensor 1250 can be comprised of sensing parts such as piezo electrics. In various aspects, the force sensor 1250 can comprise multiple sensing elements arranged about the force sensor 1250. The force sensor 1250 can be about ring shaped and have a diameter 1255 of about 80.00 mm, or as close to the diameter 1215 as possible. In various aspects, the diameter 1255 can be different from the diameter 1215. In the current aspect, the force sensor 1250 can define a collar recess 1252 sized to accept the collar portion 1216 of the ball screw nut 1210. In the current aspect, a diameter 1258 of the collar recess 1252 can be about 56.00 mm, or 0.05 mm larger than a diameter 1217 of the collar portion 1216 and about the same diameter as the diameter 1243 of the sensor location portion 1242. As such, the force sensor 1250 can be located along the sensor location portion 1242 with a tight fit—and, in some cases, with an interference fit—to ensure a snug engagement with the ball screw nut 1210 and the nut housing 1220. Similarly, the force sensor 1250 can define a plurality of fastener apertures 1268. The fastener apertures 1268 can match the location, size, and number of fastener apertures 1218 located on the ball screw nut 1210. The force sensor 1250 can be of a width 1269 of about 10 mm, or about the same as the length 1244 of the sensor location portion 1242. The force sensor 1250 can also comprise an electrical connector 1270 for communication of data from the force sensor 1250. The connector 1270 can be sized smaller than the width 1269 to avoid being damaged when the force sensor 1250 is arranged between the ball screw nut 1210 and the nut housing 1220.

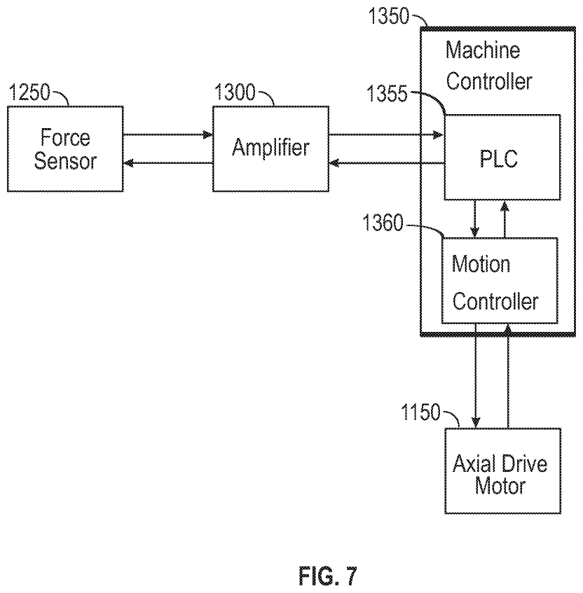

In various aspects, the force sensor 1250 can be connected to an amplifier 1300 as seen with reference to FIG. 7. The amplifier 1300 can also be connected to a Machine Controller 1350, which can be integrated with a machine that controls the friction welder assembly 1000. In various aspects, the machine controller 1350 can comprise a programmable logic controller (PLC) 1355 and a motion controller 1360. Sensed data of loads placed on the load cell of the force sensor 1250 can generate an electrical signal that can be communicated to the amplifier 1300. The electrical signal can be amplified by the amplifier 1300, and the amplified signal can then be communicated to the machine controller 1350. Based on the sensed load, the machine controller 1350 can generate instructions to a central control system to regulate the welding process of the welder assembly 1000. In particular, in response to the sensed load on the force sensor 1250, the machine controller 1350 can decide that the load is too great or too little to achieve the desired constancy of welding forces. The machine controller 1350 can then communicate instructions to the machine—in various aspects, a CNC milling machine or similar apparatus—to actuate the axial drive motor 1150. Actuation of the axial drive motor 1150 can cause the ball screw 1100 to turn, thereby actuating the translation assembly 1200 through the engagement of the ball screw nut 1210 with the ball screw 1100. The ball screw nut 1210 can then actuate against the nut housing 1220, with the force generated translating into the workpieces 100 through the welding mechanism 1050. When the ball screw nut 1210 is forced against the nut housing 1220, the force sensor 1250 can read the amount of force imparted between the two elements, thereby generating a new electrical signal in response to the sensed force, thereby renewing the cycle of control. In various aspects, control algorithms can be generated to ensure constant workpiece engagement by monitoring the load imparted on the workpieces 100—and the rate of change thereof—through the feedback loop of the force sensor 1250 through the amplifier 1300 to the machine controller 1350. In various aspects, the machine controller 1350 can in turn communicate back through the amplifier 1300 to the force sensor 1250.

The arrangements of the machine controller 1350 and the various apparatus disclosed herein can allow the welder assembly 1000 to maintain constant engagement force at a preset force level. In various aspects, the welder assembly 1000 can maintain constant engagement force at maximum of 5% deviance from a spec force value. In various aspects, the welder assembly 1000 can maintain constant engagement force at maximum of 10% deviance from a spec force value. In various aspects, the welder assembly 1000 can maintain constant engagement force at maximum of 15% deviance from a spec force value. One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A welder assembly comprising:
a welding mechanism;
a carriage plate, the welding mechanism fixedly coupled to the carriage plate;
a translation assembly, the carriage plate fixedly coupled to the translation assembly, the translation assembly comprising a force sensor;
a ball screw, the translation assembly moveably coupled to the ball screw; and,
an axial drive motor coupled to the ball screw,
wherein the ball screw is movably coupled to the translation assembly such that rotation of the axial drive motor forces linear translation of the translation assembly.

2. The welder assembly of claim 1, the translation assembly comprising a ball screw nut and a nut housing, wherein the force sensor is arranged between the ball screw nut and the nut housing such that linear force applied to the ball screw nut is applied to the force sensor and to the nut housing.

3. The welder assembly of claim 2, wherein the ball screw nut defines a shoulder portion and a collar portion, wherein the force sensor defines a collar recess sized to accept the collar portion.

4. The welder assembly of claim 3, wherein the collar portion further comprises a sensor location portion, the sensor location portion being of a diameter to engage the force sensor in interference fit.

5. The welder assembly of claim 2, wherein the force sensor is electrically connected to a circuit, the circuit configured to read force sensor data to determine the force applied to the force sensor.

6. The welder assembly of claim 5, wherein the circuit is electrically connected to the axial drive motor, and wherein the circuit includes control instructions to control the axial drive motor in response to force sensor data.

7. The welder assembly of claim 6, wherein the control instructions are configured to maintain constant force.

8. The welder assembly of claim 6, wherein the control instructions are configured to maintain within 5% deviance from constant force.

9. The welder assembly of claim 2, wherein the welding mechanism comprises a spindle motor coupled to the carriage plate and a tool connected to the spindle motor.

10. The welder assembly of claim 2, wherein the axial drive motor is coupled to a motor mount, wherein the motor mount is coupled to a support, wherein the ball screw is rotatably coupled to the support at an upper end of the ball screw and at a lower end of the ball screw, and wherein the support comprises a plurality of linear rails.

11. The welder assembly of claim 10, wherein a plurality of rail runners are fixedly coupled to the carriage plate, the rail runners arranged to engage in linear actuation with the linear rails.

12. A force-sensing attachment for a welder assembly, the force-sensing attachment comprising:
a carriage plate;
a translation assembly, the carriage plate fixedly coupled to the translation assembly, the translation assembly comprising a force sensor; and
a linear actuator, the translation assembly moveably coupled to the linear actuator.

13. The force-sensing attachment of claim 12, the translation assembly comprising an inner collar coupled to the linear actuator and a housing coupled to the carriage plate, wherein the force sensor is arranged between the inner collar and the housing such that linear force applied to the inner collar by the linear actuator is applied to the force sensor and to the housing.

14. The force-sensing attachment of claim 13, wherein the inner collar defines a shoulder portion and a collar portion, wherein the force sensor defines a collar recess sized to accept the collar portion.

15. The force-sensing attachment of claim 14, wherein the collar portion further comprises a sensor location portion, the sensor location portion being of a diameter to engage the force sensor in interference fit.

16. The force-sensing attachment of claim 13, wherein the force sensor is electrically connected to a circuit, the circuit configured to read force sensor data to determine the force applied to the force sensor.

17. The force-sensing attachment of claim 16, wherein the circuit is electrically connected to the linear actuator, and wherein the circuit includes control instructions to control the linear actuator in response to force sensor data.

18. The force-sensing attachment of claim 17, wherein the control instructions are configured to maintain force within 10% of a spec force value

19. The force-sensing attachment of claim 17, wherein the control instructions are configured to maintain force within 15% of a spec force value

20. A method of controlling a welding apparatus, the method comprising:
obtaining force sensor data from a force sensor located within a translation assembly, the translation assembly being fixedly coupled to a carriage plate and being movably coupled to a ball screw, wherein the translation assembly comprises a ball screw nut coupled to the ball screw and a nut housing coupled to the carriage plate, wherein the force sensor is arranged between the ball screw nut and the nut housing; and
rotating the ball screw to modify the amount of force sensed by the force sensor.
